(19) United States
(12) Patent Application Publication
(10) Pub. No.: US 2014/0048284 A1
(43) Pub. Date: Feb. 20, 2014

(54) Drill Rod Break-Out Wrench and Method of Use

(71) Applicants: Timothy S. Gallagher, Lumberton, NJ (US); Donald W. Alexander, Tabernacle, NJ (US)

(72) Inventors: Timothy S. Gallagher, Lumberton, NJ (US); Donald W. Alexander, Tabernacle, NJ (US)

(21) Appl. No.: 13/588,091

(22) Filed: Aug. 17, 2012

(51) Int. Cl. E21B 19/16; B25B 13/50

(52) U.S. Cl. 166/377; 81/120

(57) ABSTRACT

A drill rod break-out wrench is utilized to disengage and remove drill rods from a drill string. The wrench has a lower body section with a flat, cut-out cavity configured to receive the upper end of the topmost drill rod in a drill string. The upper body section of the wrench is configured to be connected to the drill head. Rotation of the drill head rotates the wrench and the drill rod located within the wrench to threadably disengage the drill rod from the adjacent drill rod below.

### BACKGROUND OF THE INVENTION

Long lengths of segmented pipe, or more accurately drill pipe or drill rods, are required when drilling water, gas, crude oil, or similar wells. The drill rods are made up of lengths of pipe having male and female threads at opposite ends. The pipes are threadably connected by engagement of the male threads at the bottom of one pipe to female threads at the top of an adjacent pipe. As the drilling process progresses, an additional drill rod is threaded onto the immediately adjacent lower drill rod, thus forming an elongated drill rod string, comprising threadably interconnected pipe.

When the drilling operation has been completed, or the drill rod string is no longer required at the drilling site, the lengthy string of drill rods must be withdrawn. This necessarily requires pulling up the drill rod string and unthreading each individual length of pipe as it reaches the surface. This drill rod disengaging process is often difficult, as the threaded drill rods are tightly threaded together.

Large drill rigs utilize huge, expensive systems to disengage threaded drill rod strings. However, for smaller drill rigs, such systems are impractical and expensive. On these rigs, wrenches, “cheaters”, or similar manual tools are used. However, these commonly utilized tools are often ineffective or inefficient in separating drill rods. Many such tools fail to grip the rods securely, causing them to slip off of the rods as a rotating force is being applied, often resulting in the rods being damaged.

Of course, the wrenches and similar tools which are commonly used require workers to manually disconnect the drill rods. This necessitates employing physical human force and thus the success of the work is dependent on the strength of the worker himself. As a result, the process is not only inefficient and time consuming, but subjects workers to injury to their hands, arms, backs etc.

### SUMMARY OF THE INVENTION

It is thus the object of the present invention to provide a drill rod break-out wrench which addresses the limitations and disadvantages of the prior tools and prior methods of disengaging threaded drill rods in a drill rod string.

It is the object of the present invention to provide a drill rod break-out wrench which is attached directly to the drill head and to the drill rod to be removed, in order to allow the power of the drill head to release the connection between the drill rods.

It is another object of the present invention to provide a drill rod break-out wrench which eliminates the need for workers to manually remove drill rods from the drill string, thus making the removal operation more efficient while decreasing risk of worker injury.

These and other objects are accomplished by the present invention, a drill rod break-out wrench having a lower body section with a flat, cut-out cavity configured to receive the upper end of the topmost drill rod in a drill string. The upper body section of the wrench is configured to he connected to the drill head. Rotation of the drill head rotates the wrench and the drill rod located within the wrench to threadably disengage the drill rod from the adjacent drill rod below.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an elevation view of the break-out wrench of the present invention.

FIG. 2 is a bottom view of the break-out wrench of the present invention.

FIG. 3 is a view of the break-out wrench of the present invention in position over the upper end of a drill rod.

FIG. 4 shows the break-out wrench of the present invention in the process of being used to remove a drill rod.

FIG. 5 shows the completed removal of a drill rod, having been removed using the break-out wrench of the present invention.

### DETAILED DESCRIPTION OF THE INVENTION

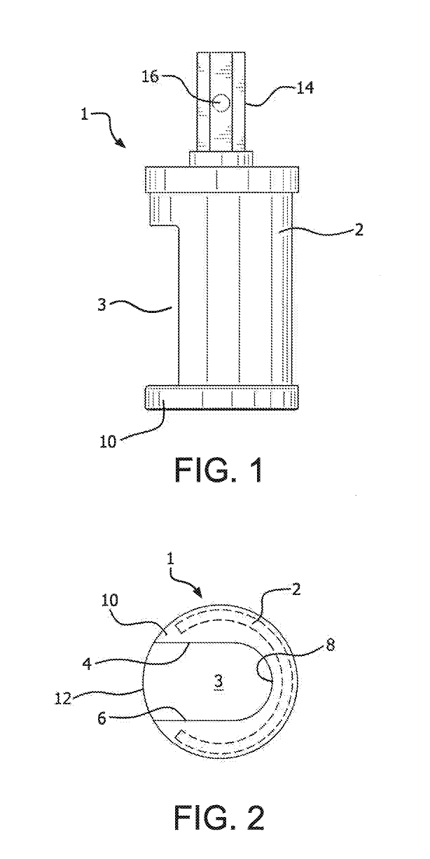

Break-out wrench 1 comprises a unitary lower body section 2 having cut-out cavity 3 extending at least one-half and, as shown in FIG. 1, substantially more than one-half the length of the lower body section. Cavity 3 has substantially flat side walls 4 and 6 and rounded back wall 8. The cavity is configured to receive upper end 22 of drill rod 20.

Lower body section 2 also comprises rim 10 located below cavity 3. Rim 10 completely circumscribes lower body section 2, except for rim opening 12 at the front of the lower body section below the cavity. Rim 10 is configured to extend into cut-out section 24 of drill rod 20.

Wrench 1 further comprises upper body section 14 which extends up from lower body section 2. The upper body section has through opening 16 configured to accept c-clip 18 or similar attachment device for connecting wrench 1 to drill head 30.

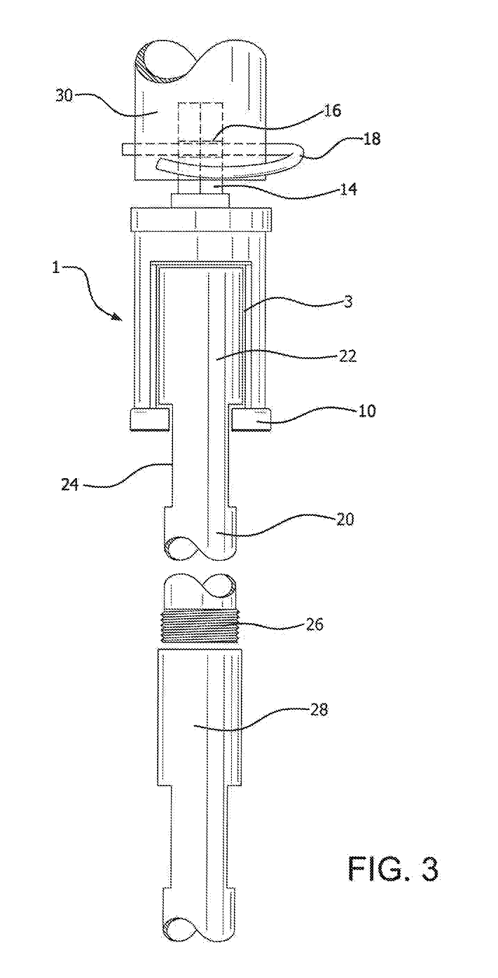

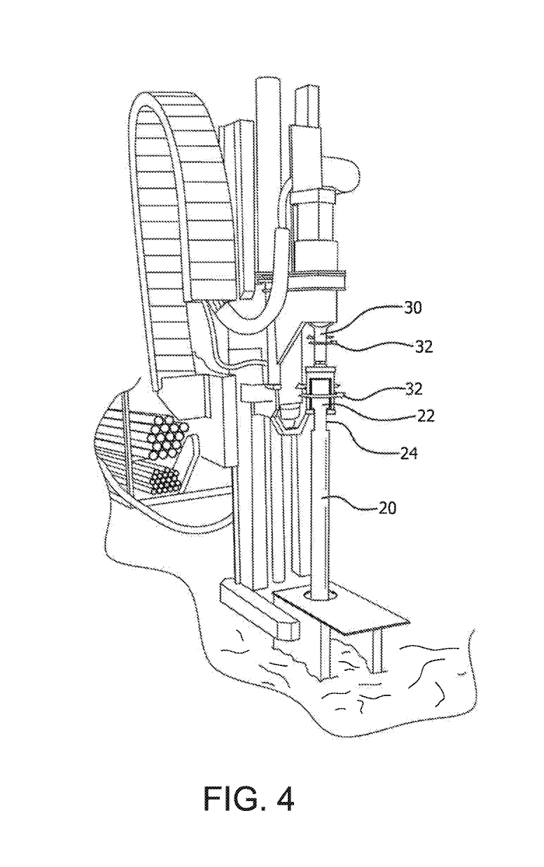

Wrench 1 is used to disengage individual threaded drill rods in a string of drill rods as follows. Wrench 1 is first connected to drill head 30 by c-clip 18 or similar attachment device. Upper end 22 of the uppermost drill rod 20 is inserted into cut-out cavity 3, such that lower body section 2 surrounds and fits snugly around the upper end of the drill rod. See FIG. 3. Drill head is then turned on and rotated in counter-clockwise direction 32, which results in wrench 1 and attached drill rod 20 being similarly rotated. Thus results in the lower threaded end 26 of drill rod 20 being unscrewed from immediately adjacent drill rod 28 located below. See FIG. 4.

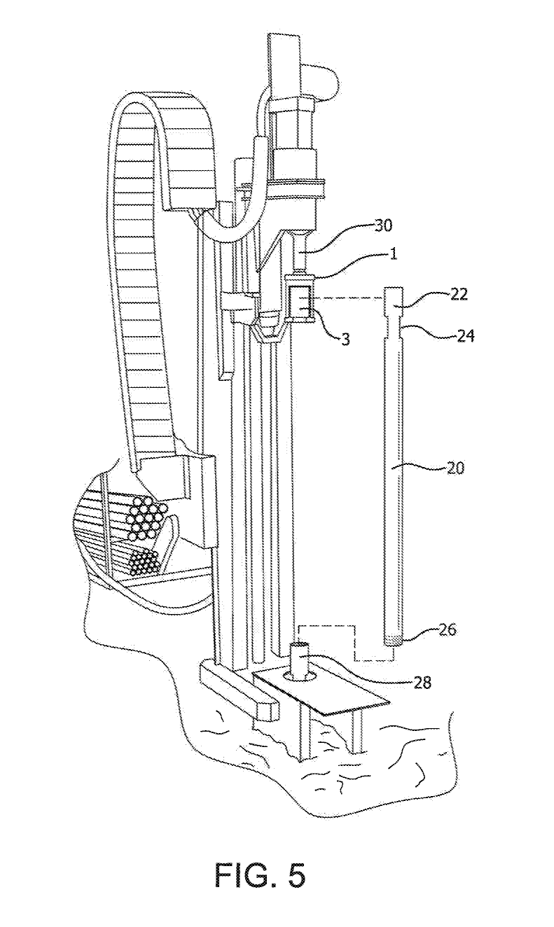

Once drill rod 20 is completely disengaged from drill rod 28, wrench 1 is rotated off and away from drill rod 20 and the drill rod is removed from the wrench. See FIG. 5. Wrench 1 is then positioned on the upper end of drill rod 28 and the process is repeated in disengaging and removing that drill rod from the adjacent drill rod below and in disengaging and removing all subsequent drill rods in the drill string.

The use of break-out wrench 1 and as described, takes advantage of the mechanical force of the drill head already on site, in removing drill rods in a drill string, thereby eliminating the physical, manual efforts of workers. The present invention thus results in a much more efficient, effective, and safe drill rod removal operation.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A drill rod break-out wrench used with a drill head to disengage a string of adjacent, threadedly engaged drill rods, each drill rod having an upper end with a flat cut-out section, said wrench comprising:
a unitary lower body section comprising a cut-out cavity, said cavity being configured to receive and be positioned around the upper end of a drill rod in the drill rod string, said lower body section further comprising a rim around the body section and below the cavity, said rim being configured to extend into the flat, cut-out section of the drill rod; and
an upper body section extending upward from the lower body section, said upper body section having means to connect the wrench to a drill head, whereby upon connection of the wrench to the drill head and the positioning of the cut-out cavity around the upper end of the drill rod, the drill head is rotated to rotate the drill rod and disengage it from an adjacent drill rod in the drill rod string.

2. The drill rod break-out wrench as in claim 1 wherein the upper body section is configured to be inserted into and accepted by the drill head and the means to connect comprises a clip securing the wrench to the drill head.

3. The drill rod break-out wrench as in claim 1 wherein the cut-out cavity is at least one-half the length of the lower body section.

4. A method of disengaging a string of adjacent, threadably engaged drill rods attached to a drill head, each drill rod having an upper end with a flat cut-out section, said method comprising the steps of:
providing a break-out wrench having a cut-out cavity;
connecting the wrench to the drill head;
inserting the upper end of the uppermost first drill rod in the drill rod string into the cut-out cavity of the wrench;
rotating the drill head, resulting in the rotation of the wrench and said first drill rod;
continuing the rotation of the drill head, wrench, and first drill rod until said drill rod is disengaged from its adjacent drill rod, the second drill rod in the drill rod string;
lifting the wrench and first drill rod;
removing the wrench from the first drill rod; and
removing the first drill rod from the drill rod string.

5. The method as in claim 4 wherein a rim is provided around the bottom of the wrench and the method comprises the further step of inserting the rim into the flat cut-out section of said first drill rod, whereby the rim assists in lifting said first drill rod.

6. The method as in claim 5 comprising the further step of inserting the upper end of the second drill rod into the cut-out cavity of the wrench.

7. The method as in claim 6 comprising the further steps of rotating the drill head, resulting in the rotation of the wrench and said second drill rod;
continuing the rotation of the drill head, wrench, and second drill rod until the second drill rod is disengaged from its adjacent drill rod, the third drill rod in the string;
lifting the wrench and second drill rod;
removing the wrench from the second drill rod; and
removing the second drill rod from the string. The method as in claim 7 comprising the further steps of removing subsequent drill rods from the drill rod string by repeating the steps set forth in claim 3 as to those drill rods and their adjacent drill rods.
